(19) United States
(12) Patent Application Publication
(10) Pub. No.: US 2002/0059388 A1
(43) Pub. Date: May 16, 2002

(54) E-mail and messaging systems and methods

(76) Inventors: David Thompson, Austin, TX (US); Siddarth Subramanian, Austin, TX (US); Dennis Parker, Leander, TX (US)

Correspondence Address: H. Dale Langley, Jr., The Law Firm of H. Dale Langley, Jr., P.C., 610 West Lynn, Austin, TX, 78703, US

(21) Appl. No.: 09/982,508

(22) Filed: Oct. 17, 2001

Related U.S. Application Data
(60) Provisional application No. 60/241,095, filed on Oct. 17, 2000.
(60) Provisional application No. 60/177,329, filed on Jan. 21, 2000.
(60) Provisional application No. 60/180,649, filed on Feb. 7, 2000.
(60) Provisional application No. 60/220,730, filed on Jul. 26, 2000.
(60) Provisional application No. 60/241,096, filed on Oct. 17, 2000.
(60) Provisional application No. 60/241,087, filed on Oct. 17, 2000.
(60) Provisional application No. 60/240,985, filed on Oct. 17, 2000.

(51) Int. Cl. G06F 15/16

(52) U.S. Cl. 709/206; 709/203

(57) ABSTRACT

A communications service provider provides wireless access to a packetized data network, such as the Internet. The service provider includes a server computer. The server computer is connected to the network, which is at least in part a wired network. The wired network is connected to a cellular wireless communications system. The server computer communicates with an e-mail server of the network according to standard network protocols. E-mail messages are served by the e-mail server to the server computer. The e-mail messages are manipulated and maintained at the server computer until requested by an e-mail application of a client device, such as a wireless device. An interface resident at the client device communicates with the e-mail application and the server computer. The interface serves to translate from and into optimized protocols for communications between the interface and the server computer.

### CROSS-REFERENCE TO RELATED APPLICATIONS

The present application is related to U.S. patent application (CPA) Ser. No. 08/852,557, entitled “Remote Digital Image Viewing System and Method”, filed May 7, 1997 (CPA filed Oct. 26, 1999); U.S. Provisional Patent Application No. 60/177,329, entitled “Wireless Network System and Method”, filed Jan. 21, 2000; U.S. Provisional Patent Application No. 60/180,649, entitled “Digital Image Transfer System and Method”, filed Feb. 7, 2000; and U.S. Provisional Patent Application No. 60/220,730, entitled “Wireless Network System and Method”, filed Jul. 26, 2000, each of the same inventor hereof, and those respective applications are incorporated herein. The present application is also related to U.S. Provisional Patent Application No. 60/241,096, entitled “Wireless ASP Systems and Methods,” filed Oct. 16, 2000, U.S. Provisional Patent Application No. 60/541,086, entitled “Wireless Communications Invisible Proxy and Hooking Systems and Methods,” filed Oct. 16, 2000, U.S. Provisional Patent Application No. 60/241,087, entitled “Wireless Communications Protocols and Architectures Systems and Methods,” filed Oct. 16, 2000, and U.S. Provision Patent No. 60/240,985, entitled “Browser and Network Optimization Systems and Methods,” filed Oct. 16, 2000.

### BACKGROUND OF THE INVENTION

The present invention generally relates to communications systems and methods and, more particularly, relates to e-mail and messaging systems and methods in low-bandwidth networks, such as wireless communications networks.

E-mail and similar messaging is widely used in network communications. Conventional e-mail applications, however, have not been particularly concerned with optimization in low-bandwidth networks, such as wireless communications networks. Undesired e-mails, sometimes referred to as “spam”, have become prevalent. This further congests the available bandwidth and network infrastructures of communications networks. In wireless communications, bandwidth and data rates are subject to inherent limitations of architectures and protocols of those systems, and conventional e-mail applications do not account for and adapt to the limitations in order to optimize operations.

Wireless application server provider (ASP) systems and methods are disclosed in the related applications. These disclosures contemplate various optimizations and adaptations of conventional communications networks for employment in wireless environments. E-mail and messaging systems and methods are also important in such environments, and are particularly applicable in connection with wireless ASP services and features.

It would be a significant improvement in the art and technology to provide improved e-mail (and similar messaging) systems and methods for optimal use in low-bandwidth communications networks, such as, for example, wireless networks and with wireless ASP services and features.

### SUMMARY OF THE INVENTION

An embodiment of the invention is a wireless application service provider (ASP) communications network. The ASP network includes a wired network, a wireless channel, a wireless application service provider server computer connected to the wired network, an e-mail server connected to the wired network and communicatively connected to the wireless application service provider service computer, a wireless packetized data communications provider equipment connected to the wired network, a client device communicatively connected via the wireless channel to the wireless packetized data communications provider, an e-mail application operable at the client device, and an interface communicatively connected to the wireless application service provider server computer and the e-mail application.

Another embodiment of the invention is a method of wireless communications. The method includes serving a first message to a wireless ASP server computer over a network according to standardized protocols, serving the first message to an interface over the network according to optimized protocols, and translating the first message at an interface to format the first message for use by an e-mail application at a client device.

### BRIEF DESCRIPTION OF THE DRAWINGS

The present invention is illustrated by way of example and not limitation in the accompanying figures, in which like references indicate similar elements, and in which:

FIG. 1 illustrates a wireless application service provider (ASP) system; and

FIG. 2 illustrates an e-mail system according to embodiments of the present invention;

FIG. 3 illustrates a method of operation of a client device of the wireless e-mail system of FIG. 1, according to embodiments of the present invention;

FIG. 4 illustrates a method of a server computer of the wireless e-mail system of FIG. 1, according to embodiments of the present invention;

FIG. 5 illustrates a method of e-mail system optimization using an e-mail list, according to embodiments of the present invention; and

FIG. 6 illustrates another method of e-mail system optimization using data mining at the server computer, according to embodiments of the present invention.

### DETAILED DESCRIPTION OF PREFERRED EMBODIMENTS

Wireless ASP

Referring to FIG. 1, a system 10 serves as a wireless application service provider (ASP). The system 10 includes a network, such as the Internet 12. The network is operable according to a packetized data protocol, such as transport control protocol/Internet protocol (TCP/IP) or some other network protocol. The network, such as the Internet 12, interconnects various computing and communications devices, for example, among other devices, a server computer 14 and a wireless ASP server computer 16. The server computer 14 and the wireless ASP server computer 16 are each one or more server computers including a microprocessor, memory storage, and communications capabilities via wire or wireless connection with the Internet 12. The server computer 14 and the wireless ASP server computer 16 communicate over the Internet 12 or other network via the protocol of the network.

The network, such as the Internet 12, is also connected with a wireless communications service provider 18. The wireless communications service provider 18 is, for example, a cellular or other packetized data wireless communications network. The wireless service provider 18 connects by wire connection with the network, such as the Internet 12. Alternatively, the wireless communications service provider 18 could connect with the network 12 by other communications connection, such as fiber optic, coax cable, wireless channel, or other communications connection. Furthermore, although the wireless communications service provider 18 is illustrated as a single particular communications channel, multiple links and multiple channels of those links, for example, communications links of wired and wireless channels, can alternatively provide the same functions and are included for purposes of the description.

The wireless service provider 18 is capable of communicating through wireless channels with various devices, such as a wireless device 20. The wireless device 20 is a processing device, such as a data-enabled cellular telephone, a personal digital assistant, a laptop computer, or any of a wide variety of other processing devices that can wirelessly communicate with the wireless service provider 18. Of course, the wireless device 20 includes communications equipment for accomplishing the wireless communication with the wireless service provider 18, such as wireless modem.

The wireless device 20 communicates through the wireless service provider 18 and over the network, such as the Internet 12, with the wireless ASP server computer 16. The wireless ASP server computer 16 serves as a dedicated server for the wireless device 20 in its communications. The wireless ASP server computer 16 sends and receives communications to and from the wireless device 20 over the network, such as the Internet 12, and on through the wireless service provider 18. The wireless ASP server computer 16 also communicates over the network, such as the Internet 12, with other network connected devices, such as the server computer 14, via protocols in communications channels enabled for such communications on the network. In certain embodiments, for example, the wireless ASP server computer 16 and the wireless device 20 communicate with specialized protocols, such as optimized packetized data protocols, for example, optimized TCP/IP protocols or other protocols such as described in the related patent applications.

Client E-mail Interface

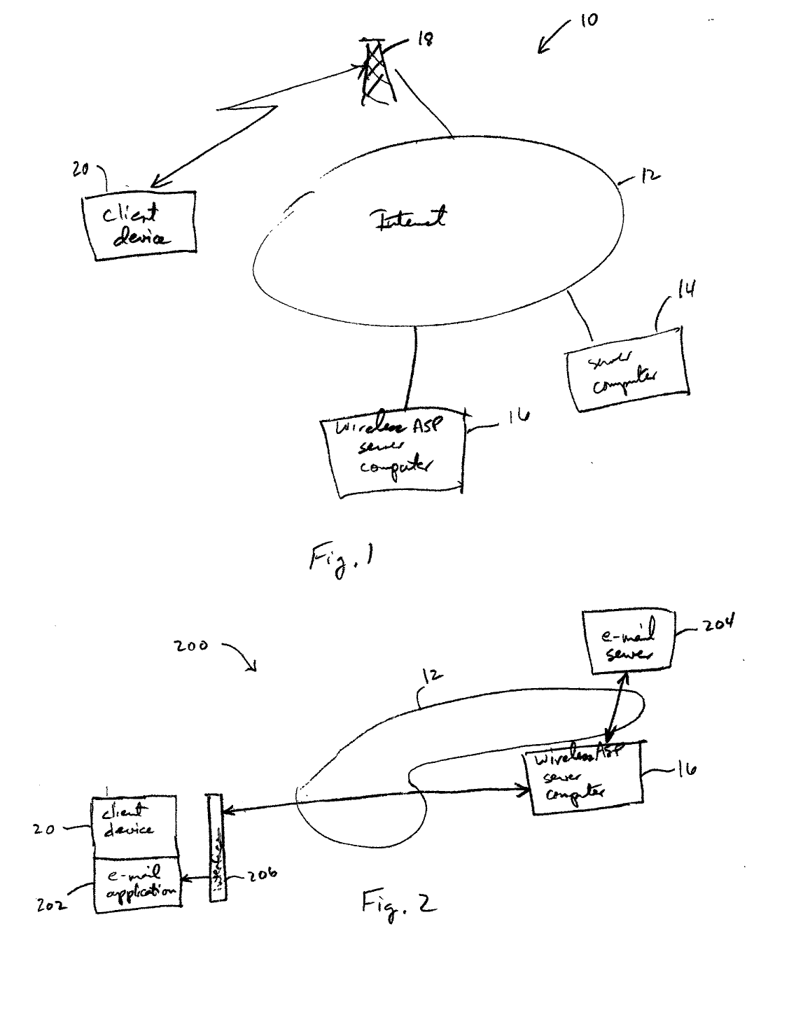

Referring to FIG. 2, an e-mail system 200 include a network, such as the Internet 12, and the wireless device 20 and the wireless ASP server computer 16 connected over the network. Additionally, the e-mail system 200 includes an e-mail server 204 communicatively connected with the wireless ASP server computer 16, for example, by the Internet 12 or other connection. As is typical, the e-mail server 204 maintains and makes available e-mail messages being communicated over the network and is conventional, such as Yahoo™ e-mail, MSN™ mail, Netscape™ e-mail, and the like.

The wireless device 20 is communicatively connected, either as a software or hardware implemented method or system resident on the wireless device 20 or otherwise communicatively accessed thereby, to an e-mail application 202. The e-mail application 202 is any conventional or specialized e-mail client application that operates on the wireless device 20 to send, receive, and view e-mail and similar messages. As is conventional, the e-mail application 202 can have a wide variety of features and additional applications integrated or functional therewith. Examples of the e-mail application 202 include Eudora Mail™, Microsoft Messenger™, and Netscape Communicator™, among others.

In addition to the e-mail application 202 communicatively connected to the wireless device 20, the wireless device 20 is communicatively connected with an interface 206. For e-mail communications between the wireless device 20 and the Internet 12, including elements of such network, the interface 206 resides between the Internet 12 and the wireless device 20, in order that the interface 206 intercepts and sends on communications from the Internet 12 to the e-mail application 202 of the wireless device 20 and from the e-mail application 202 of the wireless device 20 to the Internet 12 and its elements. The interface 206, its system and method, is implemented in software or hardware, and is retained on, at, or in conjunction with the wireless device 20, for example, in memory, a card or plug-in, or other connected device or peripheral.

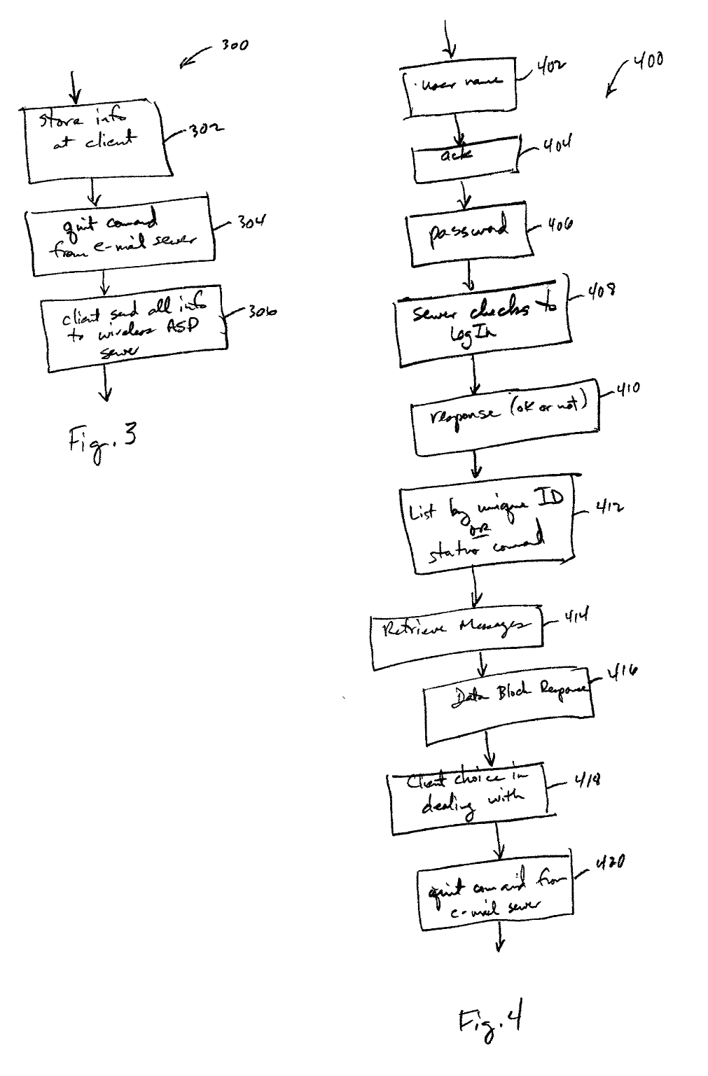

Referring to FIG. 3, a method 300 of operation of the interface 206 of FIG. 2 commences with a step 302 of storing information, to be sent as e-mail or similar messaging, at the wireless device 20. The information can include, for example, one or more e-mail messages each having (or not) various attachments and inclusions, such as text documents (e.g., HTML, Word™, or other document or text files), image files (e.g., gif, jpg, mpg or other), audio files (e.g., .wav, mp3, or other) and other data or file types. These one or more e-mail messages are stored at the wireless device 20 in the step 302 until appropriate time for sending by the wireless device 20.

In a step 304, an appropriate time for sending by the wireless device 20 occurs, such as, for example, a quit command is then processed at the e-mail server 204. The quit command in the step 204, or an indicator thereof, is communicated to the wireless device 20 over the network to notify the wireless device 20 of that state. Although a quit command of the step 204 is employed in the embodiments because of the particular operations of the wireless ASP server computer 16 described herein and in the related patent applications, it is to be understood that other indicators and other appropriate time for sending periods can be employed where applicable, in keeping with the concepts here.

The wireless device 20 thereafter, in a step 306, sends all then stored e-mail and similar messages to the wireless ASP server computer 306. The wireless device 20 sends the e-mails over the network, such as the Internet 12. The interface 206 at the wireless device 20 serves to cause the wireless device 20 to store the e-mails in the step 302 and to send the e-mails in the step 306. In operation, the e-mail application 202 at the wireless device 20 operates in typical manner; that is, a user of the wireless device 20 enters a new e-mail message, includes any relevant attachments to the message, and then initiates a send command of the e-mail application 202. Rather than the e-mail then being sent over the network by the wireless device 20, however, the e-mail is passed to the interface 206. The interface 206 causes the wireless device 20 (or the interface 206, itself, as the case may be) to store the e-mail, together with any other e-mail messages then stored, until an appropriate time for sending, such as after the step 304. In effect, the interface 206 serves to group messages for sending at optimal times for the particular network and server operations.

At the wireless device 20, via the interface 206, the messages then stored can be manipulated in various manners to optimize bandwidth and communications with the wireless ASP server computer 16. For example, the e-mail messages (and any attachments) can be compressed, sorted, mined for limited information or data, or otherwise handled to minimize data that is communicated and to limit bandwidth required for the communications. Moreover, the storage of messages until an appropriate time for sending serves to aggregate messages to alleviate repetitive calls and control signals, to optimize compression by compressing features together or otherwise, and for other manipulations designed to optimize and minimize.

Referring to FIG. 4, a method 400 optimizes e-mail and similar message communications maintained at and receivable from the wireless ASP server computer 16. The wireless ASP server computer 16 receives e-mail messages from the e-mail server 204 over the network, for example, the Internet 12. As later described, the wireless device 20 communicates with the wireless ASP server computer 16 to retrieve the e-mail messages. In addition to serving to deliver e-mail messages to the wireless device 20, however, the wireless ASP server computer 16 serves to optimize compression, limit data amounts, filter content, prioritize messages, and discard or segregate messages for sending to the wireless device 20.

In the method 400, the wireless ASP server computer 16 communicates with the e-mail server 204 substantially as though it is the e-mail application in order to receive and manipulate the e-mail messages at the e-mail server 204 that are intended for the wireless device 20. Particularly, e-mail messages for the wireless device 20, as well as all other devices operating in conjunction with the wireless ASP server computer 16, are communicated to the wireless ASP server computer 16 by the e-mail server 204. The wireless ASP server computer 16 then stores messages, with relative identifiers corresponding to the wireless device 20 and any other connected devices to which the messages are directed. Additionally, the wireless ASP server computer 16 performs various manipulations and handling of the messages, such as, for example, filtering, prioritizing, compressing, and redacting prior to sending.

In a step 402 of the method 400, the wireless ASP server computer 16, in response to a log-in prompt of the e-mail server 204, sends an appropriate user name or other login and authentication entry corresponding to the wireless device 20 to the e-mail server 204. The e-mail server 204 then responds with an acknowledgement in a step 404 that the entry in the step 402 was received. In a next step 406, the wireless ASP server computer 16, in response to another log-in prompt of the e-mail server 204, sends to the e-mail server 204 an appropriate password or other log-in and authentication entry corresponding to the ultimate receiving device, such as the wireless device 20.

In a step 408, the e-mail server 204 checks the log-in entries from the wireless ASP server computer 16 and responds in a step 410 with an acceptable, or not acceptable, signal to the wireless ASP server computer 16, based on whether or not the log-in is successful. Once the log-in operations are completed, the wireless ASP server computer 16 is presented with any of several possible displays and options. The wireless ASP server computer 16 is, for example, presented in a step 412 with a list, such as by unique identifier or status command, as the next communication from the e-mail server 204 to the wireless ASP server computer 16. The list is a listing of e-mail messages that have been received by the e-mail server 204 and that correspond to messages intended for the wireless device 20 and other devices served by the wireless ASP server computer 16.

In a step 414, the wireless ASP server computer 16 retrieves the e-mail messages from the wireless ASP server computer 16. The retrieved messages are stored on or in connection with the wireless ASP server computer 16, so that the wireless ASP server computer 16 can serve the messages, as applicable, to the wireless device 20 or other appropriate device of the network.

In addition to storing the retrieved messages, the wireless ASP server computer 16 can perform various manipulations with the e-mail messages once retrieved. For example, in a step 416, the wireless ASP server computer 16 can block or discard messages received that are not to be sent to the wireless device 20. The wireless ASP server computer 16 can make determinations to block or discard in the step 416 based on pre-set programming of the server computer 16, signals from the wireless device 20 with commands regarding such matters, or other mechanisms. In a step 418, for example, the wireless device 20 or other intended e-mail recipient client device in communication with the wireless ASP server computer 16 chooses handling of various e-mail messages at the wireless ASP server computer 16 according to the choices available based on server computer 16 programming and the application.

A next step 420 is a quit command from the e-mail server

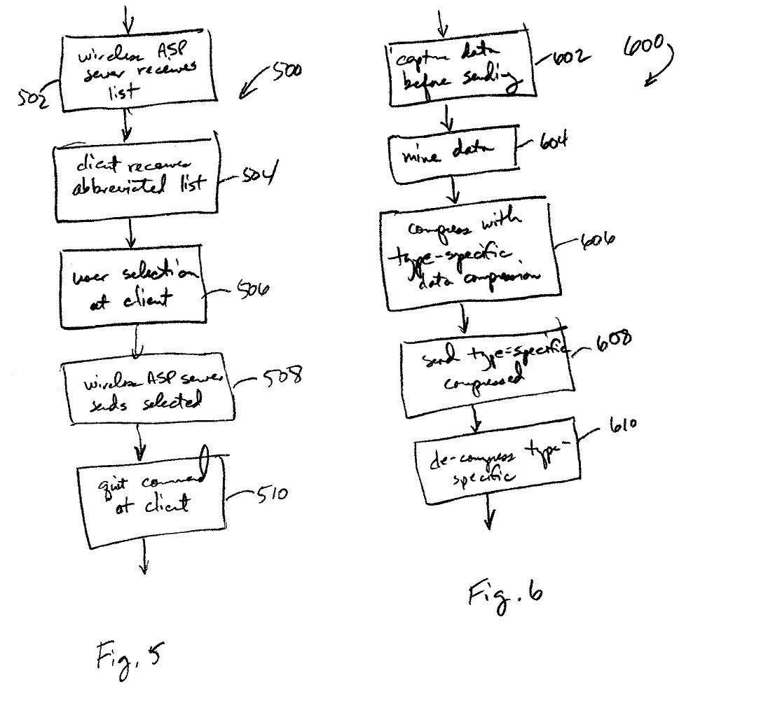

Referring to FIG. 5, a method 500 is performed in communication of e-mail and similar messages at the wireless ASP server computer 16 to the wireless device 20 (or other appropriate client device in communication with the server computer 16, as the case may be). In a step 502, the wireless ASP server processes a listing of the e-mails corresponding to respective client devices, such as the wireless device 20. The list is then abbreviated by the wireless ASP server computer 16 according to its programming and the choices made and communicated to the server computer 16 by the wireless device 20 or other client device, as applicable.

In a step 506, the user of the wireless device 20 chooses and notifies the wireless ASP server computer 16 over the network which e-mail messages to download from the wireless ASP server computer 16 to the wireless device 20. Additionally, the wireless device 20 could make other or further choices and selections. In any event, the displays and options at the wireless device 20 are limited, with a view to reduction of number of communications required between the wireless device 20 and the wireless ASP server computer 16 and limitation of the quantity of data of the communications to reduce bandwidth requirements.

For example, the wireless device 20 is not given all e-mail details, such as certain e-mails can be filtered out from the list by the server computer 16, abbreviated “From” and “Subject” descriptions may be provided, any attachments may be indicated or not, and other abbreviated or limited information regarding the available e-mails for the wireless device 20 are presented. Further, the wireless device 20 could make various choices for dealing with the e-mail message at the wireless ASP server computer 16. For example, certain of the choices are conventionally performed at the ultimate recipient but can instead be performed at the wireless ASP server computer 16, such as delete, save and forward. Other choices could include signals to the wireless ASP server computer 16 to block download of future messages from the source, other disposition of messages received, sorting of received messages, further filtering of messages and their content, and numerous others all with a view to limiting processing and storage required of the wireless device 20 and limiting bandwidth and number of communications between the wireless device 20 and the wireless ASP server computer 16.

In a step 508, the wireless ASP server computer 16 sends to the wireless device 20 the e-mail messages for the wireless device 20 which the server computer 16, based on its programming and the wireless device 20 choices, determines to send. The chosen messages, but none others, are then downloaded from the wireless ASP server computer 16 to the wireless device 20 over the network. Numerous additional controls are available at the wireless device 20 to limit or choose the messages to be retrieved in the step 508. For example, the wireless device 20 could signal the wireless ASP server computer 16 to discontinue download of a particular message or attachment, set or change priorities for download sequence of the messages, and otherwise alter the download that is received.

In a step 510, the wireless device 20, after receiving the e-mail messages from the wireless ASP server computer 16, processes a quit command.

Referring to FIG. 6, a method 600 is performed by the interface 206 in order to receive to serve as an intermediary between the wireless ASP server computer 16 and the e-mail application 202 of the wireless device 20. The interface 206 is required in order that the e-mail application 202 can be a standard, conventional application. Because the wireless ASP server computer 16 changes e-mail lists, provides added compression, and provides choices for selection by the wireless device 20, and other nuances different from those typically encountered when communicating directly with the e-mail server 204, the interface 206 must communicate with the wireless ASP server computer 16 and also must change information and messages received at the interface 206 to forms useable and readable by the e-mail application 202.

In the method 600, a step 602 captures data from the e-mail application 202 that would be sent over the network if not intercepted by the interface 206. This data so captured by the interface 206 is mined in a step 604 to determine the data types present in the data. Once the data types are determined, a step 606 of the interface 206 compresses the data according to type-specific data compression techniques. The interface 206 then sends the type-specific compressed data to the wireless ASP server computer 16 in a step 608. At the wireless ASP server computer 16, the compressed data once received is decompressed according to the type-specific compression employed at the interface 206.

In communications from the wireless ASP server computer 16 to the interface 206, the same, but reversed direction, steps are employed. That is, the wireless ASP server computer 16 captures data from the e-mail server 204, mines the data, and then compresses the data using type-specific data compression techniques. The wireless ASP server computer 16 then sends the compressed data over the network to the wireless device 20. At the wireless device 20, the communication is intercepted by the interface 206. The interface 206 de-compresses the data according to the type-specific compression employed. The interface 206 then makes the de-compressed information available to the e-mail application 202 in form acceptable to the e-mail application 202, in effect, as though the interface 206 performs the e-mail server 204 function in connection with the e-mail application 202.

In operation of the systems 10, 200 and the methods 300, 400, 500, 600, numerous alternative business and technical arrangements are possible. In certain embodiments, the administrator of the wireless ASP server computer 16 can provide select interfaces and content to the wireless device 20 or other client device of the network. For example, the wireless device 20 can be equipped with a form of World Wide Web (WWW) browser that performs according to the specialized protocols for the communications between the wireless device 20 and the wireless ASP server computer 16. In such instance, the wireless ASP server computer 16 can provide to the wireless device 20 according to those same specialized protocols various data and information, including such things as graphics, images, voice, text, and other digitally represented information and matters.

The wireless ASP server computer 16 must also, however, be capable of communicating via typical network protocols with other network connected devices, such as the e-mail server 204, in order to receive and deliver messages from and to those network connected devices, and then transfer those messages on or receive those messages from the wireless device 20, as appropriate. Of course, the interface 206 serves the function of transforming or translating from proprietary or specialized e-mail communication formats and protocols of the wireless ASP server computer 16 to standardized formats and protocols of the e-mail application 202. In this sense, the interface 206 is a gateway between the wireless device 20 and the wireless ASP server computer 204, and functions to allow standard e-mail programs and formats to operate in an environment of specialized protocols for wireless communications, for example, the protocols disclosed in the related patent applications.

Although only particular devices of a communications network and its nodes, particularly, wireless device 20, the wireless ASP server computer 16, the wireless service provider 18, the server computer 14, the e-mail server 204, the e-mail application 202, the interface 206, and the network, such as the Internet 12, have been described with regard to the embodiments, it is to be expressly understood that combinations of those elements, such as a plurality of any, certain ones, all of those elements, and even additional or alternative elements, is possible in keeping with the scope of the embodiments herein. The network could be an intranet, or even an intranet combination or intranet-extranet combination. Numerous banks of the wireless ASP server computer 16 can be possible for receiving communications from pluralities of wireless devices, and the wireless ASP server computers can be centrally located or distributed through a wide geographic area. In the case of a global network such as the Internet, the network is capable of communicating by its protocols, which may include other specialized protocols for specific situations. The wireless ASP server computer in such instance can communicate with various devices on the network according to those other specialized protocols, if properly equipped as would be known to those skilled in the art. In general, the communications between the wireless device or devices and the wireless ASP server computer or computers occur according to optimized protocols for wireless communications. These optimized protocols can be implemented entirely in software or alternatively can be hardware, combinations of hardware and software, or other mechanisms. The protocols of the hardware or software, as the case may be, for the wireless communications will, in any event, provide increased communications efficiency, speed, and adaptation for the wireless environment.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A wireless communications network, comprising:
a wired network;
a wireless channel;
a server computer connected to the wired network;
an e-mail server connected to the wired network and communicatively connected to the server computer;
a wireless packetized data communications provider equipment connected to the wired network;
a client device communicatively connected via the wireless channel to the wireless packetized data communications provider;
an e-mail application operable at the client device; and
an interface communicatively connected to the server computer and the email application.

2. The wireless communications network of claim 1, wherein the e-mail application is a standard e-mail client software residing on the client device and complying with standard e-mail messaging formats and protocols.

3. The wireless communications network of claim 2, wherein the e-mail server communicates over the network with the server computer via conventional network protocols.

4. The wireless communications network of claim 3, wherein the e-mail application and the server computer each communicate with the interface.

5. The wireless communications network of claim 2, wherein the wired network is the Internet.

6. The wireless communications network of claim 1, wherein the wireless channel is a cellular packetized data system.

7. The wireless communications network of claim 1, wherein the wireless channel is a CDPD system.

8. A method of wireless communications, comprising the steps of: serving a first message to a server computer over a network according to standardized protocols;
serving the first message to an interface over the network according to optimized protocols; and
translating the first message at an interface to format the first message for use by an e-mail application at a client device.

9. The method of claim 8, wherein the step of serving to the server computer is performed using TCP/IP.

10. The method of claim 9, wherein the first message is served by the server computer to the interface via a wireless channel and optimized protocols.
